(19) United States
(12) Patent Application Publication
(10) Pub. No.: US 2017/0192081 A1
(43) Pub. Date: Jul. 6, 2017

(54) POSITION DETECTION SYSTEM

(71) Applicant: ALPS ELECTRIC CO., LTD., Tokyo (JP)

(72) Inventor: Yukimitsu YAMADA, Tokyo (JP)

(21) Appl. No.: 15/461,566

(22) Filed: Mar. 17, 2017

Related U.S. Application Data
(63) Continuation of application No. PCT/JP2015/072853, filed on Aug. 12, 2015.

(30) Foreign Application Priority Data
Sep. 17, 2014 (JP) 2014-189461

(51) Int. Cl. G01S 5/02; G01S 11/06; G01C 5/06

(52) U.S. Cl. CPC G01S 5/0263; G01C 5/06; G01S 11/06

(57) ABSTRACT

A position detection system includes a mobile body including a first atmospheric pressure sensor, a fixed station including a second atmospheric pressure sensor, and a distance measurement sensor that measures a distance between the mobile body and the fixed station. A position of the mobile body is determined on a basis of height information, obtained from an output of the first atmospheric pressure sensor and an output of the second atmospheric pressure sensor, and the distance.

### CLAIM OF PRIORITY

This application is a Continuation of International Application No. PCT/JP2015/072853 filed on Aug. 12, 2015, which claims benefit of Japanese Patent Application No. 2014-189461 filed on Sep. 17, 2014. The entire contents of each application is incorporated herein by reference.

### BACKGROUND OF THE INVENTION

1. Field of the Invention

The present invention relates to a position detection system for detecting the position of a mobile body such as an automobile or the like.

2. Description of the Related Art

The mobile body monitoring system disclosed in Japanese Unexamined Patent Application Publication No. 2006-101290 obtains the position information regarding a test vehicle as a mobile body through position determination arithmetic operation using the output signal of a position determination satellite and a position compensation parameter that compensates for a position determination error that depends on a distance from the reference position of an electronic reference station.

In the mobile body monitoring system disclosed in Japanese Unexamined Patent Application Publication No. 2006-101290, the position of a test vehicle on a running course is determined using a triangular method on the basis of a distance from the reference position of an electronic reference station. Hence, since the position is determined by using only a distance without using height information, a positional error on a horizontal plane may be generated. Further, determination errors may accumulate when accumulation determination is performed using an acceleration sensor or an angular velocity detection gyroscope.

### SUMMARY OF THE INVENTION

The present invention provides a position detection system that can determine the position of a mobile body with high accuracy by using height information. Further, the present invention provides a position detection system in which determination errors are unlikely to accumulate even when determination is repeated, as a result of position detection being performed without using a speed sensor or an angular detection gyroscope.

A position detection system of the present invention includes: a mobile body including a first atmospheric pressure sensor; a fixed station including a second atmospheric pressure sensor; and a distance measurement sensor that measures a distance between the mobile body and the fixed station. A position of the mobile body is determined on a basis of height information, obtained from an output of the first atmospheric pressure sensor and an output of the second atmospheric pressure sensor, and the distance.

As a result, the position of the mobile body can be determined more accurately than in determination using only a distance measurement sensor. Further, since position detection is performed without using an acceleration sensor or an angular velocity detection gyroscope, accumulation of determination errors is unlikely to occur even when the determination is repeated.

In the position detection system of the present invention, it is preferable that the height information be a difference in height between the mobile body and the fixed station.

By using a difference in height, high-accuracy determination can be performed while suppressing an influence of atmospheric pressure variations due to weather. Further, the determination is unlikely to be influenced by the size of the mobile body or an electronic tag attachment position.

In the position detection system of the present invention, it is preferable that the fixed station be provided in a plurality at positions different from one another, and regarding each of the fixed stations, the position thereof be determined on a basis of the height information regarding a difference in height from the mobile body and the distance from the mobile body.

As a result, the accuracy of detecting the position of a mobile body can be further enhanced. Further, even when one of the fixed stations enters an abnormal state, position detection can be performed by using a signal from the rest of the fixed stations.

In the position detection system of the present invention, it is preferable that the plurality of the fixed stations be provided respectively on a plurality of floors, and be respectively provided at different positions on the corresponding floors.

As a result, the position of a mobile body can be detected on any floor, in a building having a plurality of floors. Further, the position can be detected by identifying the floor on which a mobile body exists on the basis of the position information regarding the plurality of fixed stations or the direction information obtained on the basis of a signal from the electronic tag, and in accordance with a signal from the fixed station closest to the mobile body.

In the position detection system of the present invention, it is preferable that the distance measurement sensor include a transmission and reception unit that is provided in the mobile body and that transmits a measurement signal and receives a response signal and a transmission and reception unit that is provided in the fixed station and that receives the measurement signal and transmits the response signal corresponding to the measurement signal, and the distance measurement sensor calculates the distance on a basis of the measurement signal and reception strength of the response signal in the mobile body.

Since an existing distance measurement sensor using an RF signal or the like can be used, a low-cost and high-precision position detection system can be formed.

### BRIEF DESCRIPTION OF THE DRAWINGS

FIG. 1 is a block diagram illustrating the system configuration of a position detection system according to an embodiment of the present invention;

FIG. 2 is a side view illustrating a schematic configuration of the position detection system according to an embodiment of the present invention;

FIG. 3 is a side view illustrating the schematic configuration of a position detection system according to a first modification; and

FIG. 4 is a side view illustrating the schematic configuration of a position detection system according to a second modification.

### DESCRIPTION OF THE PREFERRED EMBODIMENTS

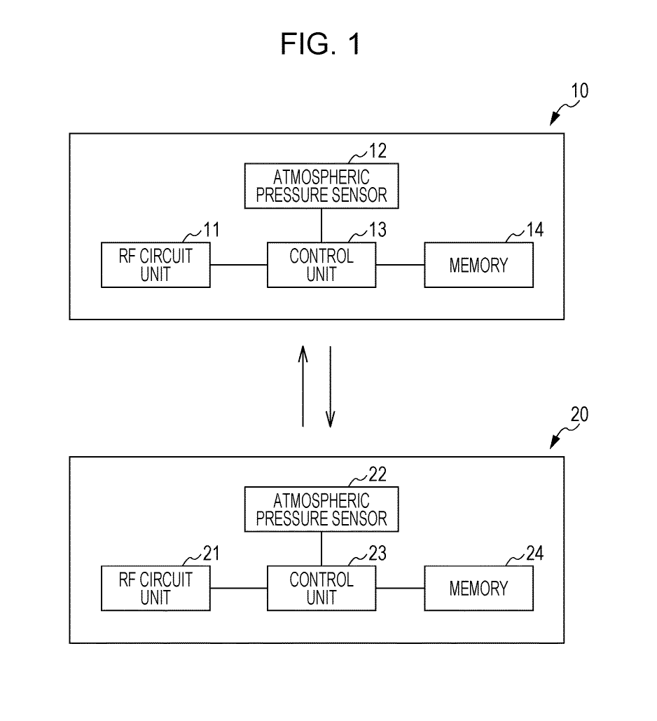

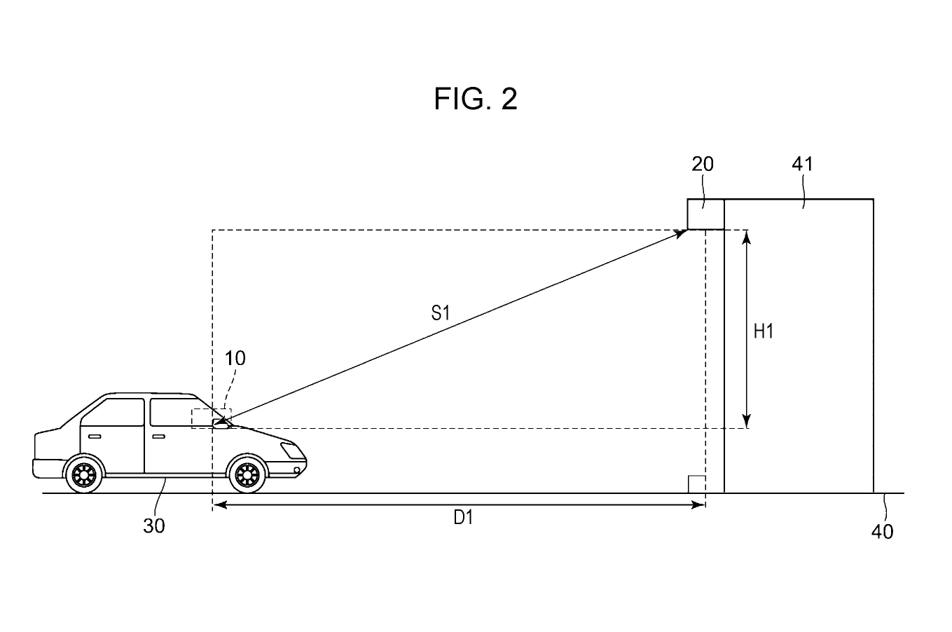

Hereinafter, a position detection system according to an embodiment of the present invention will be described in detail with reference to the drawings. FIG. 1 is a block diagram illustrating the system configuration of the position detection system according to the present embodiment. FIG. 2 is a side view illustrating a schematic configuration of the position detection system according to the present embodiment. Note that in FIG. 1 and FIG. 2, an electronic tag 10 and a first fixed station 20 are illustrated in an enlarged manner for convenience of explanation.

As illustrated in FIG. 1, the position detection system according to the present embodiment includes the electronic tag 10 provided in a mobile body and the first fixed station 20 that can perform mutual communication with the electronic tag 10.

The mobile body is, for example, an automobile 30 illustrated in FIG. 2 and may be a two-wheeler, a person, or a product in a physical distribution center. The case in which the mobile body is a person corresponds to a case where the person is carrying a card or a mobile apparatus housing the electronic tag 10.

As illustrated in FIG. 2, for example, the first fixed station 20 is fixed to a fixed structure 41 such as a column, provided on a movement plane 40 such as a road where the automobile 30 moves.

As illustrated in FIG. 1, the electronic tag 10 includes an RF circuit unit 11, an atmospheric pressure sensor 12 (first atmospheric pressure sensor), a control unit 13, and a memory 14. The first fixed station 20 includes an RF circuit unit 21, an atmospheric pressure sensor 22, a control unit 23, and a memory 24. In the description below, the position which becomes the measurement reference for the distance between the first fixed station 20 and the automobile 30 and the height of the automobile 30 is a position at which the electronic tag 10 is provided. However, instead of this, the distance and the height may be defined such that the center of gravity of the automobile 30 or the center position of the automobile 30 in terms of its external shape is the reference.

The RF circuit unit 11 of the electronic tag 10 and the RF circuit unit 21 of the first fixed station 20 each include a transmission and reception unit that can transmit and receive a radio-frequency signal (RF signal) (for example, a radio frequency signal of 10 kHz or higher). The RF circuit unit 11 of the electronic tag 10 transmits a measurement signal for measuring the distance between the automobile 30 and the first fixed station 20. The measurement signal is stored in the memory 14 in advance and is transmitted at a timing instructed by the control unit 13. When the RF circuit unit 21 of the first fixed station 20 receives a measurement signal transmitted from the RF circuit unit 11 of the electronic tag 10, the control unit 23 measures the signal strength of the received measurement signal and makes the RF circuit unit 21 transmit the measurement result as a response signal. When the RF circuit unit 11 of the electronic tag 10 receives this response signal, the control unit 13 calculates a distance between the electronic tag 10 and the first fixed station 20 on the basis of the signal strength detected by the RF circuit unit 21. Here, the RF circuit unit 11 of the electronic tag 10 and the RF circuit unit 21 of the first fixed station 20 constitute a distance measurement sensor. Note that the RF circuit units 11 and 21 may be configured as respective units different from the atmospheric pressure sensors 12 and 22.

The reception unit of the RF circuit unit 21 of the first fixed station 20 includes three reception antennas having sensitivity in three respective directions orthogonal to one another. The control unit 13 calculates the direction in which the electronic tag 10 is located on the basis of the relationships among the strengths of signals received by the respective reception antennas of the RF circuit unit 11. The calculation result is attached to an RF signal transmitted from the RF circuit unit 21 and transmitted to the electronic tag 10.

The atmospheric pressure sensor 12 of the electronic tag 10 and the atmospheric pressure sensor 22 of the first fixed station 20 are sensors that measure the respective atmospheric pressures of the locations of the sensors, and each use, for example, an electrostatic capacitance sensor or a vibration sensor. In the case of an electrostatic-capacitance-type sensor, the wall portions of a chamber formed of, for example, silicon form the electrodes of a capacitor, and detects a change in the distance between the electrodes due to an atmospheric pressure as a change in electrostatic capacitance. In the case of a vibration-type sensor, vibration is applied from a piezoelectric device made of, for example, crystal to a chamber formed of, for example, a metal or silicon, and the tension of a chamber surface that changes in accordance with a change in atmospheric pressure is detected as a change in resonant frequency.

The detection results obtained by the atmospheric pressure sensors 12 and 22 are respectively output to the control units 13 and 23. The detection result obtained by the atmospheric pressure sensor 22 of the first fixed station 20 is added to an RF signal transmitted from the RF circuit unit 21 and transmitted to the electronic tag 10.

The control unit 13 of the electronic tag 10 controls the operation of the RF circuit unit 11, and further performs the following processing. A program necessary for the processing and processing results are stored in the memory 14.

(1) The difference in height between the electronic tag 10 and the first fixed station 20, i.e., the difference in height between the automobile 30 and the first fixed station 20 (difference in position in the vertical direction in FIG. 2) is calculated on the basis of the detection result obtained by the atmospheric pressure sensor 12 and the detection result which is obtained by the atmospheric pressure sensor 22 and is included in the RF signal transmitted from the first fixed station 20. This difference in height is a difference H1 in the example illustrated in FIG. 2.
(2) The distance between the electronic tag 10 and the first fixed station 20 is calculated on the basis of the signal strength of the measurement signal included in the response signal transmitted from the first fixed station 20. Here, the distance between the electronic tag 10 and the first fixed station 20 described here is a distance S1 along a straight line between the electronic tag 10 and the first fixed station 20, in the example illustrated in FIG. 2.
(3) On the basis of the difference in height between the electronic tag 10 and the first fixed station 20 calculated in (1) and the distance between the electronic tag 10 and the first fixed station 20 calculated in (2) described above, the distance along the movement plane 40 between the electronic tag 10 and the first fixed station 20 is calculated. The distance along the movement plane 40 between the electronic tag 10 and the first fixed station 20, in the example illustrated in FIG. 2, is a distance Dl between a point where a vertical straight line drawn vertically from the first fixed station 20 toward the movement plane 40 is located and the electronic tag 10, and is calculated by using the Pythagorean theorem for the already calculated distance S1 and the difference H1.
(4) The position (for example, the longitude and latitude) of the first fixed station 20 has been determined in advance and the determined value has been stored in the memory 14. The control unit 13 determines the position of the electronic tag 10 (automobile 30) on the basis of the position of the first fixed station 20, the distance D1 calculated in (3) described above, and the direction in which the electronic tag 10 is located transmitted from the first fixed station 20.

Next, modifications will be described.

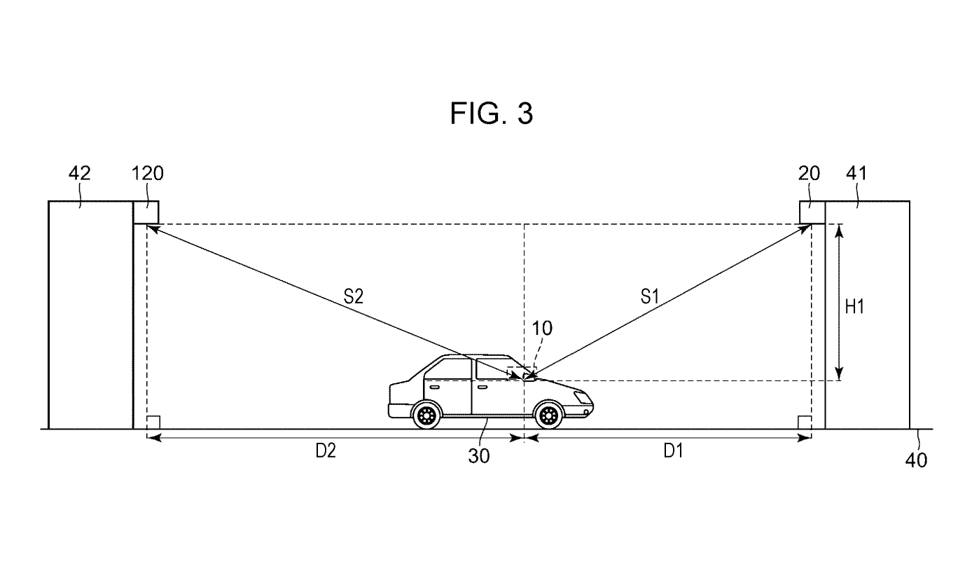

FIG. 3 is a side view illustrating the schematic configuration of a position detection system according to a first modification.

In the first modification, as illustrated in FIG. 3, other than the first fixed station 20 of the embodiment described above, a second fixed station 120 is provided on a fixed structure 42 arranged at a position on the movement plane 40 different from that of the fixed structure 41. In other words, a plurality of the fixed stations are provided on the same floor. Here, in the example illustrated in FIG. 3, the first fixed station 20 and the second fixed station 120 are provided at the same height with respect to the electronic tag 10; however, the first fixed station 20 and the second fixed station 120 may be provided at different heights.

In the control unit 13 of the electronic tag 10, similarly to the embodiment described above, on the basis of mutual communication between the electronic tag 10 and the second fixed station 120, the difference H1 in height between the electronic tag 10 and the second fixed station 120, a distance along a straight line S2 between the electronic tag 10 and the second fixed station 120, a distance D2 along the movement plane 40 between the electronic tag 10 and the second fixed station 120, and the position of the electronic tag 10 (automobile 30) are calculated. The electronic tag 10 communicates with the first fixed station 20 and the second fixed station 120 at fixed intervals.

The control unit 13 of the electronic tag 10 determines the position of the electronic tag 10 by using a predetermined program, on the basis of the position of the electronic tag 10 determined on the basis of the data received from the first fixed station 20 and the position of the electronic tag 10 determined on the basis the data received from the second fixed station 120.

This allows the position of the electronic tag 10 (automobile 30) to be detected more accurately than in the case of a single fixed station. Further, even when an obstacle exists between the automobile 30 and one of the fixed stations, or even when one of the fixed stations is in a failed state, the position of the electronic tag 10 can be detected by mutual communication with the rest of the fixed stations.

Further, by making each of the two fixed stations 20 and 120 store the position information regarding the other station and detect an abnormal state of a mounting position or communication state through mutual communication, use of data from an abnormal fixed station can be suppressed and, hence, the accuracy in position detection can be maintained in detection of the position of a mobile body.

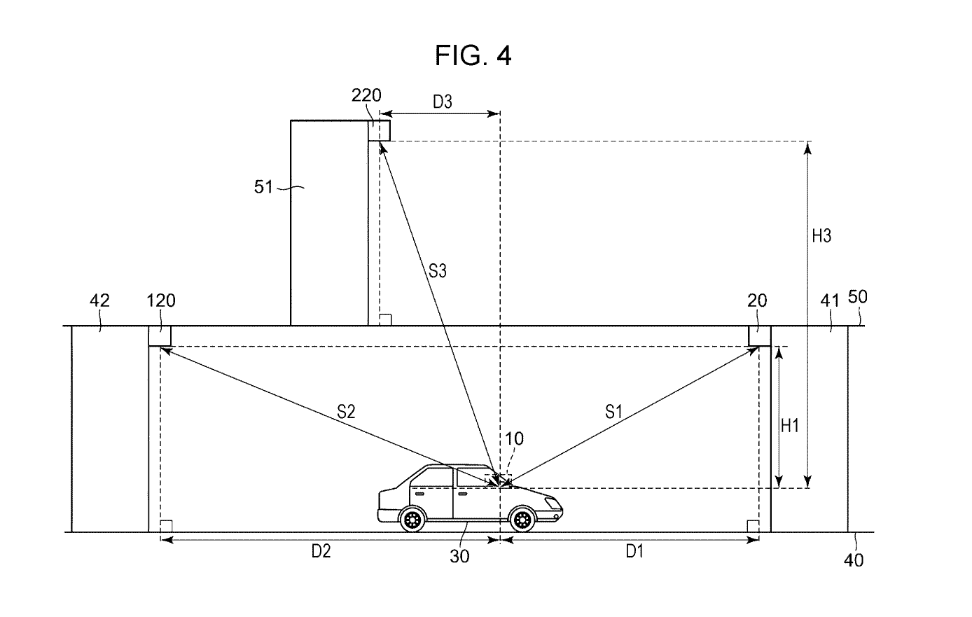

FIG. 4 is a side view illustrating the schematic configuration of a position detection system according to a second modification.

In the second modification, in addition to the two fixed stations, i.e., the first fixed stations 20 and the second fixed station 120 illustrated in FIG. 3, a third fixed station 220 is provided on a fixed structure 51 arranged on a movement plane 50 at a floor different from the movement plane 40. The two movement planes 40 and 50 are planes substantially parallel to each other. The third fixed station 220 is provided at a position different from those of the first fixed station 20 and the second fixed station 120 not only in terms of the floor but also in terms of the plane direction (left-right direction in FIG. 4).

In the control unit 13 of the electronic tag 10, similarly to the above-described embodiment and the first modification, a difference H3 in height between the electronic tag 10 and the third fixed station 220, a distance S3 along a straight line between the electronic tag 10 and the third fixed station 220, a distance D3 along the movement plane 50 between the electronic tag 10 and the third fixed station 220, and the position of the electronic tag 10 (automobile 30) are determined on the basis of mutual communication between the electronic tag 10 and the third fixed station 220. The electronic tag 10 communicates with the first fixed station 20, the second fixed station 120, and the third fixed station 220 at fixed intervals.

The control unit 13 of the electronic tag 10 determines the position of the electronic tag 10 by using a predetermined program, on the basis of the position of the electronic tag 10 determined on the basis of the data received from the first fixed station 20, the position of the electronic tag 10 determined on the basis of the data received from the second fixed station 120, and the position of the electronic tag 10 determined on the basis the data received from the third fixed station 220.

As a result, the position of the electronic tag 10 (automobile 30) can be detected further more accurately than in the case of a single fixed station. In addition, even when an obstacle exists between the automobile 30 and one of the fixed stations, the position of the electronic tag 10 can be detected by mutual communication with the rest of the fixed stations.

In the embodiments and modifications described above, a signal strength was measured on the fixed station side by transmitting a measurement signal for measuring a distance from the electronic tag 10; however, instead of this, a configuration may be employed in which by transmitting a measurement signal from the fixed station, the signal strength is measured on the electronic tag 10 side that receives the measurement signal and the distance between the electronic tag 10 and the fixed station is calculated on the basis of the signal strength. In this case, it is preferable that the electronic tag 10 transmit a request signal requesting the transmission of the measurement signal since the measurement signal need not be transmitted when the electronic tag 10 does not exist.

Further, instead of distance measurement using the reception strength of a measurement signal, the distance between the electronic tag 10 and a fixed station may be calculated on the basis of a phase difference between the measurement signal transmitted from the electronic tag 10 and a response signal transmitted from the fixed station a predetermined time later in response to the measurement signal.

According to the embodiments configured as described above, the following advantages are obtained.

(1) By using height information obtained on the basis of the output of the first atmospheric pressure sensor included in a mobile body and the output of the second atmospheric pressure sensor included in a fixed station, the position of a mobile body can be determined more accurately than in determination using only a distance measurement sensor. Further, since position detection is performed without using an acceleration sensor or an angular velocity detection gyroscope, accumulation of determination errors is unlikely to occur even when the determination is repeated.
(2) By using a difference in height between a mobile body and a fixed station as height information in (1), high-accuracy determination can be performed while suppressing an influence of atmospheric pressure variations due to weather. Further, the determination is unlikely to be influenced by the size of a mobile body or an electronic tag attachment position.
(3) By providing a plurality of fixed stations at positions different from one another, the accuracy of detecting the position of a mobile body can be further enhanced. Further, position detection can be performed even when one of the fixed stations enters an abnormal state.
(4) A plurality of fixed stations can be respectively provided on a plurality of floors. As a result, the position of a mobile body can be detected on any floor, in a building having a plurality of floors. Further, the position can be detected by identifying the floor on which a mobile body exists on the basis of the position information regarding the plurality of fixed stations or the direction information obtained on the basis of a signal from the electronic tag 10, and in accordance with a signal from the fixed station closest to the mobile body.
(5) Since there is a difference in height between a fixed station and a mobile body, it becomes easy to determine the state of the mobile body, for example, whether the mobile body is moving or stationary, or whether or not a person (mobile body) having the electronic tag 10 is stationary.

The present invention has been described with reference to the embodiments described above. The present invention is not limited to the embodiments described above and may be improved or modified, for improvement or within the scope of the concept of the present invention.

As described above, the position detection system according to the present invention is useful for realizing a position detection system with little measurement error.

1. A position detection system comprising:
a mobile body including a first atmospheric pressure sensor;
a fixed station including a second atmospheric pressure sensor; and
a distance measurement sensor that measures a distance between the mobile body and the fixed station,
wherein a position of the mobile body is determined based on height information, obtained from an output of the first atmospheric pressure sensor and an output of the second atmospheric pressure sensor, and the distance.

2. The position detection system according to claim 1, wherein the height information is a difference in height between the mobile body and the fixed station.

3. The position detection system according to claim 1, wherein the fixed station includes a plurality of fixed stations, each of the plurality of fixed stations being located at respective positions different from one another, and for each of the plurality of fixed stations, the respective position thereof is determined on a basis of the height information regarding a difference in height from the mobile body and the distance from the mobile body.

4. The position detection system according to claim 3, wherein the plurality of the fixed stations are provided respectively on a plurality of floors, and are respectively provided at different positions on the corresponding floors.

5. The position detection system according to claim 1,
wherein the distance measurement sensor includes a transmission and reception unit that is provided in the mobile body and that transmits a measurement signal and receives a response signal and a transmission and reception unit that is provided in the fixed station and that receives the measurement signal and transmits the response signal corresponding to the measurement signal, and
wherein the distance measurement sensor calculates the distance on a basis of the measurement signal and reception strength of the response signal in the mobile body.
